(19) United States
(12) Patent Application Publication
(10) Pub. No.: US 2017/0337635 A1
(43) Pub. Date: Nov. 23, 2017

(54) METHOD AND SYSTEM TO CALCULATE A DYNAMIC PERSONAL BUDGET BASED ON CHANGING ENVIRONMENTS

(71) Applicant: Bastian KNEUSE, Corte Madera, CA (US)

(72) Inventor: Bastian KNEUSE, Corte Madera, CA (US)

(21) Appl. No.: 15/598,143

(22) Filed: May 17, 2017

Related U.S. Application Data
(60) Provisional application No. 62/338,079, filed on May 18, 2016.

(51) Int. Cl. G06Q 40/00

(52) U.S. Cl. CPC G06Q 40/12

(57) ABSTRACT

Computer-implemented method and system to calculate a dynamic personal budget based on changing environments. The computer-implemented method includes extracting information from a user through an interactive series of questions and personal preferences. Further, the computer-implemented method includes gathering current economic factors such as Cost-of-Living-Index and Consumer Expenditures Report. Furthermore, the computer-implemented method includes calculating a realistic budget based on the information extracted, desired retirement goals and current economic indicators. Moreover, the computer-implemented method includes creating a personalized budget that fits into the user's lifestyle.

### TECHNICAL FIELD

Embodiments of the disclosure relate generally to personal budgets. Embodiments relate more particularly to calculate a dynamic personal budget based on changing environments.

### BACKGROUND

Generally, individuals are unable to save enough money and assets to retire comfortably and at the desired retirement age. A major reason for this is the lack of basic financial knowledge to manage their financials in a sustainable way.

Currently, there are several financial solutions such as Mint.com, smartasset.com and financialmentor.com that aid users to generate personal budgets. Mint.com provides a mobile platform to establish the desired budget categories manually and track spending progress. The users are required to enter their own budget which may not be accurate. The users are therefore required to have financial knowledge to accurately create their budget. At times, the users may forget to include unexpected expenses (one-time spending) which make the budget incomplete. Mint.com does not factor in retirement age.

Further, smartasset.com is an online platform that offers a budget calculator that requires inputs such as household income, location, adults in household and children in household. Based on these inputs, a budget is generated that represents the average budget of a person in the same neighborhood. However, smartasset.com does not factor in age/retirement age in the budget calculation. Moreover, the budget includes generic expense categories and is not detailed enough.

Furthermore, financialmentor.com is an online platform that offers a budget calculator that proposes expense ranges for each spending category by entering the net-income. The budget is generated using high level (general) assumptions. Moreover, the budget includes generic expense categories and does not factor in age/retirement age in budget calculation.

Another drawback of the current solutions fails to tie up the budget to personal goals, for instance retirement at age 65. Further, the current solutions are static and do not allow to capture life-changing events for instance, unemployment or death in family. Furthermore, the current solutions lack the ability to personalize budgets.

In spite of the existing financial solutions, creating a manual budget is extremely cumbersome (due to lack of financial knowledge). As a result, the budget may be incomplete or not realistic.

In the light of the above discussion, there appears to be a need for calculating a personal budget that can be modified based on changing environments.

### OBJECT OF INVENTION

The principal object of the embodiments herein is to generate household budget given the individual's specific circumstances and lifestyle while working towards a desired retirement age.

Another object of the embodiments herein is to dynamically adjust the budget according to changing situations of the user's experiences, for instance, unemployment, sickness, death in family and so on.

### SUMMARY

The above-mentioned needs are met by a computer-implemented method, Computer-program product and system to calculate a dynamic personal budget based on changing environments.

An example of a computer-implemented method to calculate a dynamic personal budget based on changing environments includes extracting information from a user through an interactive series of questions and personal preferences. Further, the computer-implemented method includes gathering current economic factors such as Cost-of-Living-Index and Consumer Expenditures Report. Furthermore, the computer-implemented method includes calculating a realistic budget based on the information extracted, desired retirement goals and current economic indicators. Moreover, the computer-implemented method includes creating a personalized budget that fits into the user's lifestyle.

An example of a computer program product to calculate a dynamic personal budget based on changing environments includes extracting information from a user through an interactive series of questions and personal preferences. Further, the computer program product includes gathering current economic factors such as Cost-of-Living-Index and Consumer Expenditures Report. Furthermore, the computer program product includes calculating a realistic budget based on the information extracted, desired retirement goals and current economic indicators. Moreover, the computer program product includes creating a personalized budget that fits into the user's lifestyle.

An example of a system to calculate a dynamic personal budget based on changing environments includes a computing device configured with a computer personal finance management application that generates individual budgets and combined household budgets. Further, the system includes a plurality of databases to store a plurality of financial sources, wherein the financial includes current economic factors and questionnaire data. Furthermore, the system includes a network that allows the computing device to connect to the financial sources. Moreover, the system includes a calculation module coupled to the computing device to calculate a realistic budget for a user, wherein the calculation is based on information obtained from financial sources through the network. The system also includes a processor coupled within the computing device and configured to perform: extract information from a user through an interactive series of questions and personal preferences; gather current economic factors such as Cost-of-Living-Index and Consumer Expenditures Report; calculate a realistic budget based on the information extracted, desired retirement goals and current economic indicators; and create a personalized budget that fits into the user's lifestyle.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, according to the embodiments as disclosed herein;

FIG. 2 is a flow diagram illustrating a method to calculate a dynamic personal budget based on changing environments, according to the embodiments as disclosed herein;

FIG. 3 is an exemplary illustration of the ideal budget calculation, according to the embodiments as disclosed herein; and

FIG. 4 is a block diagram of a machine in the example form of a computer system within which instructions for causing the machine to perform any one or more of the methodologies discussed herein may be executed.

### DETAILED DESCRIPTION OF THE EMBODIMENTS

The above-mentioned needs are met by a computer-implemented method, computer-program product and system to calculate a dynamic personal budget based on changing environments. The following detailed description is intended to provide example implementations to one of ordinary skill in the art, and is not intended to limit the invention to the explicit disclosure, as one of ordinary skill in the art will understand that variations can be substituted that are within the scope of the invention as described.

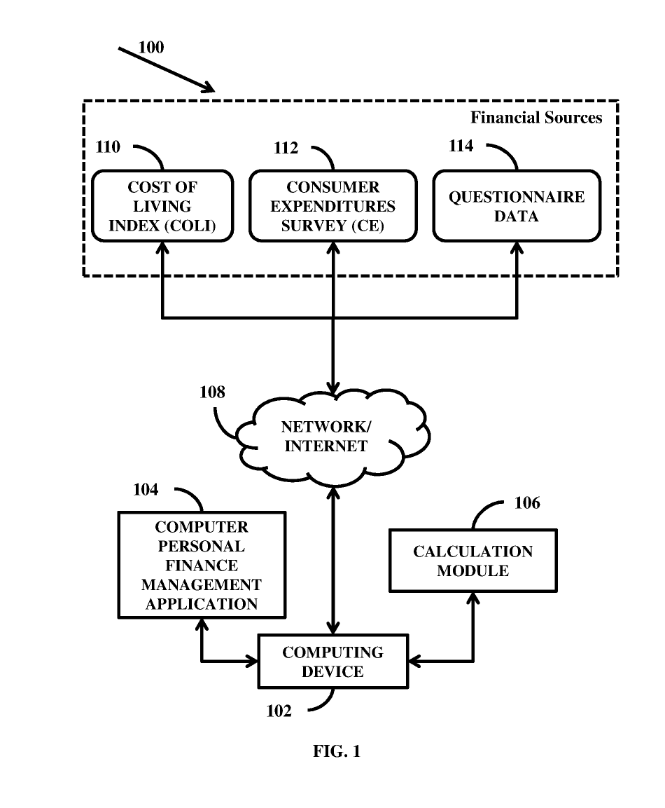

FIG. 1 is a block diagram of an environment, according to the embodiments as disclosed herein. The environment 100 includes a computing device 102, a computer personal finance management application 104, a calculation module 106, a network 108, a Cost of Living Index (COLI) 110, a consumer expenditures survey (CE) 112 and a questionnaire data 114.

The computing device 102 is a portable electronic or a desktop device configured with a user interface (not shown in FIG. 1) to interact with the user/driver. Examples of the computing device 102 include, but are not limited to, a personal computer (PC), a mobile phone, a tablet device, a personal digital assistant (PDA), a smart phone and a laptop. Examples of the user interface include, but are not limited to, display screen, keyboard, mouse, light pen, appearance of a desktop, illuminated characters and help messages.

The computing device 102 is configured with the computer personal finance management application 104. The computer personal finance management application 104 is a non-transitory computer-readable medium, the contents of which causes to perform the method disclosed herein.

It will be appreciated to those skilled in the art that, the computer personal finance management application 104 may be used for individual budgets or combined household budgets.

The calculation module 106 calculates a realistic budget for a user. Typically, the calculation is based on information obtained from financial sources through the network/Internet 108. The financial sources include the COLI 110, the CE 112 and the questionnaire data 114.

COLI 110 and CE 112 indicate current economic factors. Specifically, COLI 110 signify the cost of living in the user's locality/area. The CE 112 lists out expense data from a monthly/quarterly conducted survey. The questionnaire data 114 (also referred to as base information) is extracted in a set-up phrase through a playful and interactive series of questions and personal preferences. Consequently, the set-up phrase becomes very simple, quick, smooth and entertaining.

Upon completion of the set-up phrase, the computing device 102 utilizes all the information to calculate an “ideal/realistic” budget. Once the budget has been established, the user has the opportunity to further customize (refine) the budget to make it conform to the user's lifestyle and habits.

As the user implements the budget into their daily lives, the user will be subjected with probing questions to achieve further refinement. Further, the user is allowed to capture life-changing events and incorporate into the budget calculations. As a result, the computing device 102 suggests modifications dynamically to the budget.

It should be appreciated to those of ordinary skill in the art that FIG.1 depicts the computing in an oversimplified manner and a practical embodiment may include additional components and suitably configured processing logic to support known or conventional operating features that are not described in detail herein.

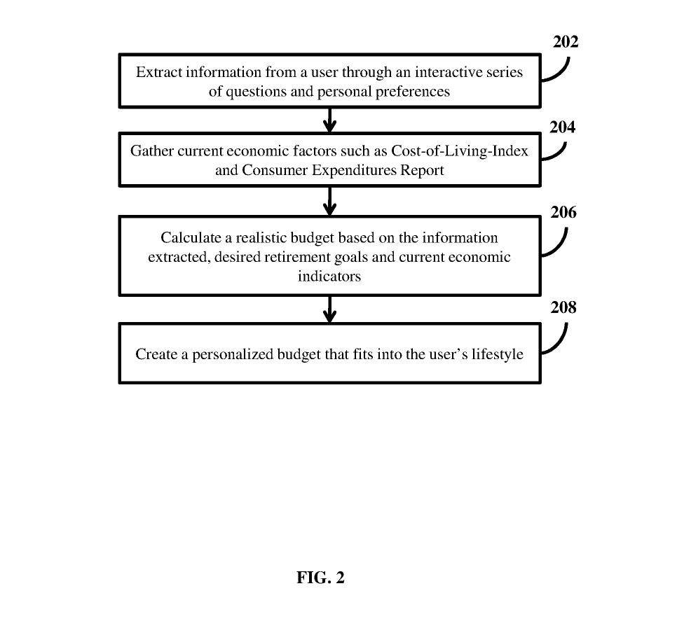

FIG. 2 is a flow diagram illustrating a method to calculate a dynamic personal budget based on changing environments, according to the embodiments as disclosed herein. The flow diagram begins at step 202 (also referred to as the initial phrase/set-up process).

At step 202, information is extracted from a user through an interactive series of questions and personal preferences. The interactive series of questions makes the set-up process very simple, quick, smooth and entertaining. Typically, the information is basic details of the user. Examples of the information includes, but is not limited to as follows:
a. Current age of adult family members in the household.
b. Location/Area: decipher between metropolitan area and rural (metropolitan areas are highly priced).
c. Children: How many children are in the household and their ages.
d. Marital status: Single/Married
e. Pets: How many and what kind (as big dogs are more expensive that small bunny)
f. Desired Retirement Age: Indicates expected retirement age (specify retirement for all individuals included in budget).
g. Dependents in household: Such as grandparents and other people to care for (excluding kids).

At step 204, current economic factors such as Cost-of-Living-Index and Consumer Expenditures Report are gathered.

At step 206, a realistic budget is calculated based on the information extracted, desired retirement goals and current economic indicators.

Typically, a budget is an estimate of income and expenditure for a set period of time. The budget may be created for a person, family, group of people, business, government and so on.

The realistic budget takes the information extracted into considered as well as desired retirement goals.

At step 208, a personalized budget is created that fits into the user's lifestyle.

As the user implements the budget into his/her daily lives, the user is faced with probing questions to achieve further refinement. Examples of the probing questions are as follows:
a. At what age do you plan on buying a house?
b. At what age do you plan on have kids? How many?
c. Do you plan on buying a new car? At what age?
d. Do you plan on buying a car for your kids?

Based on the probing questions, major purchases/expenditures planned in the short/mid-term are captured in various ways as follows:
a. The retirement age could be pushed out to account for the increased spending, while making no adjustments to the ideal budget.
b. The spend allocation on one or multiple spending categories can be slightly altered so the desired retirement age can still be achieved.
c. Increase household income, so the ideal budget and retirement age does not need to be altered.
d. Another and more risky approach would be altering the investment allocation of the investment portfolio by overweighing equities, which could result in additional capital gains. However, this approach is not reliable and therefore not recommended.

Life changing events of the user are recorded and distinguished as one of a short-term impact and a long-term impact. The life changing events are captured and incorporated into the budget calculations. As a result, the system will suggest modification to various spending categories.

Examples of life changing events include, but are not limited to, unemployment, birth of kids, death in family, kids moving out and long-term sickness.

The short-term impact is typically considered to be up to 6 months and the long-term impact is 6 months and more. In the case of the short-term impact, the budget is reduced in the non-essential spending categories. Non-essential spending categories encompass any supplemental lifestyle spending such as restaurants, movie tickets, coffee shops, vacation and so on. Only expenses for basic needs will be covered for example, electricity, transportation, groceries and so on.

The long-term impact is handled differently. Adjustments are made under the premise of still having a fulfilled life. Budget cuts are implemented across various spending categories. The main focus, however, is on big ticket spending categories such as rent payments. A possible suggestion would be to move into an apartment that has cheaper monthly rent payments or swapping the current housing arrangement with a cheaper alternative (sell house and get cheaper house with lower mortgage payments). The goal is to have expense reductions across various categories so the “pain” will be distributed evenly, while moderate lifestyle spending such as restaurants is permitted and encouraged.

The budget is modified based on the life changing events. A new budget is generated.

The user is allowed to customize the modified budget for further refinement. The user may refine the budget to make it conform to the user's lifestyle and habits. The money allocated to certain spending categories can be altered by increasing or decreasing the money allocation. For instance, 5% allocation for restaurant spending can be increased by 2 percentage points to a total of 7% as the user regularly enjoys going out to eat. However, an increase in a spending category needs to be balanced with an offsetting decrease in another spending category to keep the overall savings consistent. Alternatively, a decrease in a spending category does not need to be balanced with an offsetting increase in another category as it is desirable to increase the monthly savings amount which can ultimately lead to additional savings accumulated over time.

The flow diagram ends at step 208.

The method described herein is beneficial for several reasons as listed below:
1. Increases savings rate
2. Achieves pre-determined retirement age
3. Achieves financial independence during retirement
4. Ability to monitor and control spending
5. Accumulates enough assets to achieve desired retirement age and experience financially sound retirement.
6. Ability to adjust spending habits given life changing events while still being on track to achieve retirement age.
7. Ability to tie budget to personal goals such as retirement age, house purchase, car purchase, kids, etc.
8. No financial knowledge needed to create a complete and personalized budget
9. No fees for financial advisor
10. Automated system that provides unbiased spending guidance
11. Portable—will be implemented as a mobile application
12. Provides long-term view; set up realistic guidance on achieving financially independent retirement
13. Living within one's means

Further, the method described herein is beneficial for several categories of people as follows:
1. Consumers with less financial assets who are seeking financial guidance
2. Millennials getting established and who try to lay the ground-work for a successful retirement
3. College graduates who are trying to get established while being on their own
4. Consumers who currently utilize financial advisors, however are not satisfied with the services they receive and fees they pay
5. Consumer who currently utilize financial advisors, however are trying to get a second “opinion” (parallel use).

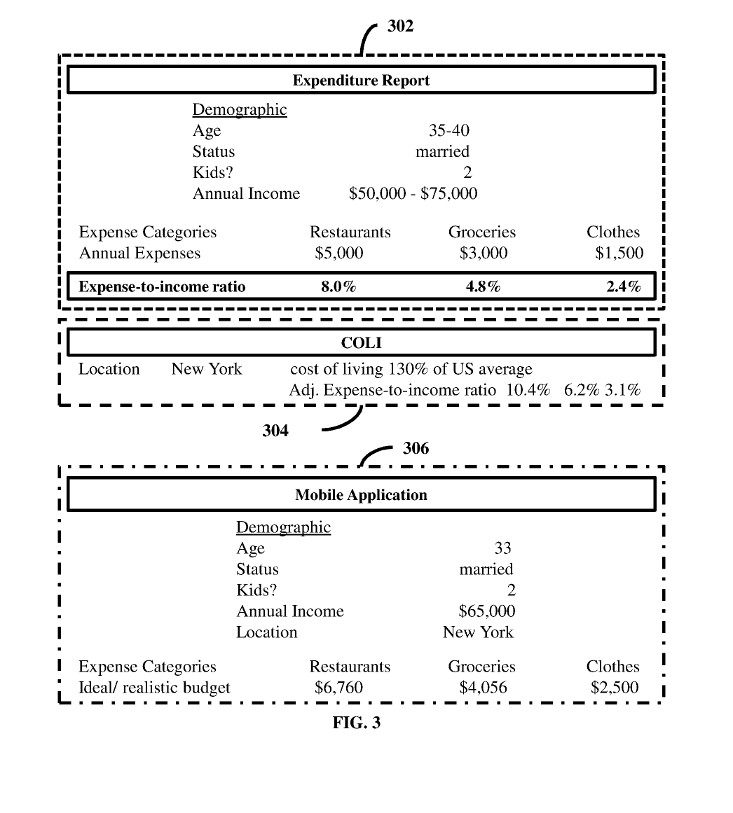

FIG. 3 is an exemplary illustration of the ideal budget calculation, according to the embodiments as disclosed herein.

The expenditure report 302 measures the expense-to-income ratios by calculating the expense amounts per expense category divided by total income. The category includes various expense categories, but is not limited to, groceries, clothes and restaurants. This is done for all individual expense categories and all individual demographics.

Based on the collected demographics in the set-up phrase, the appropriate expense-to-income are applied and adjusted through the cost-of-living-index (COLI) 304 for the appropriate location.

As a result, the adjusted expense-to-income ratios are applied to the user's total annual income, which calculates the budget for each expense category 306.

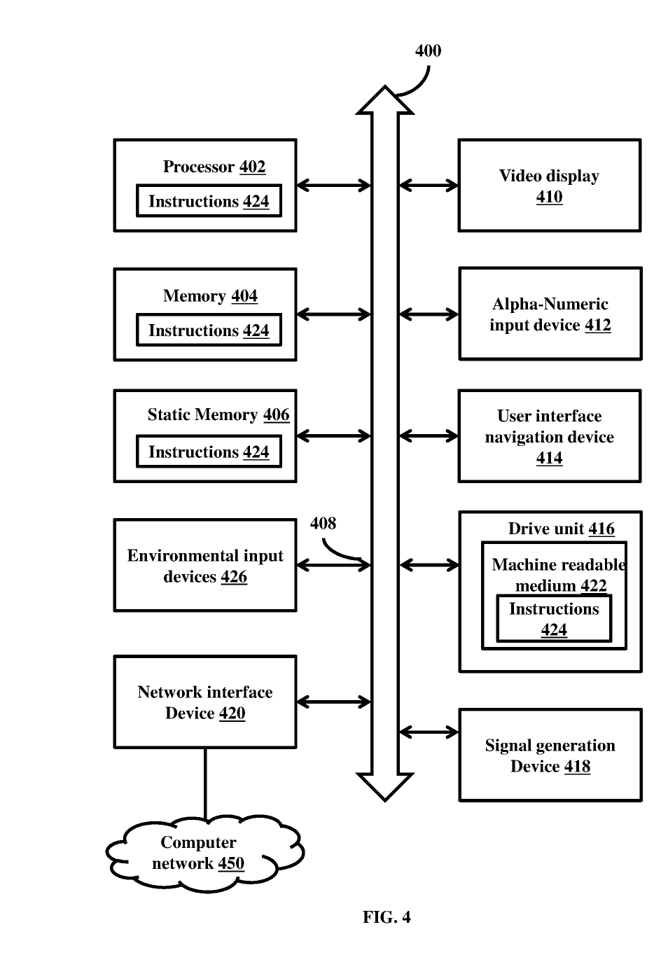

FIG. 4 is a block diagram of a machine in the example form of a computer system within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU), or both), a main memory 404, and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker), and a network interface device 420. The computer system 400 may also include an environmental input device 426 that may provide a number of inputs describing the environment in which the computer system 400 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions 424 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 424 may further be transmitted or received over a computer network 450 using a transmission medium. The instructions 424 may be transmitted using the network interface device 420 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise Java Beans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

1. A computer-implemented method to calculate a dynamic personal budget based on changing environments, the computer-implemented method comprises:
extracting information from a user through an interactive series of questions and personal preferences;
gathering current economic factors such as Cost-of-Living-Index and Consumer Expenditures Report;
calculating a realistic budget based on the information extracted, desired retirement goals and current economic indicators; and
creating a personalized budget that fits into the user's lifestyle.

2. The computer-implemented method of claim 1 wherein the personalized budget adjusts to changes in the user's lifestyle.

3. The computer-implemented method of claim 1 and further comprising:
recording life changing events of the user and distinguishing the life changing events as one of a short-term impact and a long-term impact; and
suggesting modifications to the budget.

4. The computer-implemented method of claim 3 wherein the short-term impact and long-term impact events are distinguished based on a specific time duration.

5. The computer-implemented method of claim 3 and further comprising:
modifying the budget dynamically based on the life changing events; and
allowing the user to customize the modified budget for further refinement.

6. The computer-implemented method of claim 1 and further comprising:
generating a household budget given the individual's specific circumstances and lifestyle while working towards a desired retirement age.

7. The computer-implemented method of claim 1 wherein calculating the realistic budget further comprises:
calculating an expense-to-income ratio for all individual expense categories and all individual demographics.

8. The computer-implemented method of claim 7 and further comprising:
applying an appropriate expense-to-income ratio and adjusting the cost-of-living-index for an appropriate location; and
applying the expense-to-income ratios to the users total annual income that calculates the budget for each expense category.

9. The computer-implemented method of claim 1 and further comprising:
enquiring the user with a plurality of probing questions; and
modifying the budget based on answers of the probing questions.

10. A computer program product stored on a non-transitory computer readable medium that when executed by a processor, performs a method to calculate a dynamic personal budget based on changing environments, the computer program product comprises:
extracting information from a user through an interactive series of questions and personal preferences;
gathering current economic factors such as Cost-of-Living-Index and Consumer Expenditures Report;
calculating a realistic budget based on the information extracted, desired retirement goals and current economic indicators; and
creating a personalized budget that fits into the user's lifestyle.

11. The computer program product of claim 10 wherein the personalized budget adjusts to changes in the user's lifestyle.

12. The computer program product of claim 10 and further comprising:
recording life changing events of the user and distinguishing the life changing events as one of a short-term impact and a long-term impact; and
suggesting modifications to the budget.

13. The computer program product of claim 12 wherein the short-term impact and long-term impact events are distinguished based on a specific time duration.

14. The computer program product of claim 12 and further comprising:
modifying the budget dynamically based on the life changing events; and
allowing the user to customize the modified budget for further refinement.

15. The computer program product of claim 10 and further comprising:
generating a household budget given the individual's specific circumstances and lifestyle while working towards a desired retirement age.

16. The computer program product of claim 10 wherein calculating the realistic budget further comprises:
calculating an expense-to-income ratio for all individual expense categories and all individual demographics.

17. The computer program product of claim 16 and further comprising:
applying an appropriate expense-to-income ratio and adjusting the cost-of-living-index for an appropriate location; and
applying the expense-to-income ratios to the users total annual income that calculates the budget for each expense category.

18. The computer program product of claim 10 and further comprising:
enquiring the user with a plurality of probing questions; and
modifying the budget based on answers of the probing questions.

19. A system to calculate a dynamic personal budget based on changing environments, the system comprising:
a computing device configured with a computer personal finance management application that generates individual budgets and combined household budgets;
a plurality of databases to store a plurality of financial sources, wherein the financial sources includes current economic factors and questionnaire data;
a network that allows the computing device to connect to the financial sources;
a calculation module coupled to the computing device to calculate a realistic budget for a user, wherein the calculation is based on information obtained from financial sources through the network; and
a processor coupled within the computing device and configured to perform:
extract information from a user through an interactive series of questions and personal preferences;
gather current economic factors such as Cost-of-Living-Index and Consumer Expenditures Report;
calculate a realistic budget based on the information extracted, desired retirement goals and current economic indicators; and
create a personalized budget that fits into the user's lifestyle.

20. The system of claim 19 and further comprising:
a database to store the extracted information from the plurality of sources.
